(19) United States
(12) Patent Application Publication
(10) Pub. No.: US 2010/0002452 A1
(43) Pub. Date: Jan. 7, 2010

(54) Luminaire housing with separated lamp and ballast compartments

(75) Inventors: Ranjit Devanesan Gananathan, Richmond Hill (CA); Gavin Song, Shanghai (CN); Carol Zhou, Shanghai (CN); Charles Anthony Kelpin, Senoia, GA (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 12/217,585

(22) Filed: Jul. 7, 2008

(51) Int. Cl. F21V 29/00; F21V 15/01

(52) U.S. Cl. 362/373; 362/362

(57) ABSTRACT

A luminaire housing with a lamp compartment and ballast compartment that are isolated from each other is provided. The housing includes a lamp compartment, a ballast compartment, and an air gap chamber separating the two compartments from each other. The air gap chamber provides a degree of thermal isolation that reduces the amount of heat generated by the lamps that is transferred from the lamp compartment to the ballast compartment. The luminaire can also include a ventilated top cover and a bottom door configured to attach to the lamp compartment while leaving an air gap therebetween. These and other optional features improve the air circulation within the lamp compartment and allow heat generated by the lamps to exit the luminaire housing, further reducing the heat transferred to the ballast compartment, thereby improving the lifespan and performance of the ballasts.

### TECHNICAL FIELD

The invention relates generally to light fixtures, and more specifically to a housing for a luminaire that includes a lamp compartment and a ballast compartment that are thermally isolated from each other.

### BACKGROUND

Luminaires can include one or more lamps connected to one or more ballasts that control the current flowing through the lamps. By controlling the current flowing through the lamps, the ballasts can be used to control the brightness of the lamps in the luminaires. The lamps used in luminaires, like other sources of light, often generate a significant amount of heat. The heat generated by lamps generally increases as the brightness of the lamps increases. Moreover, the heat generated by the lamps can cause damage to the ballasts. This damage can lead to a decrease in the lifespan of the ballasts, and therefore, the functionality of the luminaire.

Manufacturers of conventional luminaires have developed a few solutions to increase the lifespan of ballasts in luminaire housings, but each of these solutions has associated disadvantages and limitations. For example, luminaires can be configured to have the lamps disposed within the luminaire housing and the ballasts placed outside of—and separated from—the housing. In such cases, the ballasts may be placed at a different location from the luminaire housing altogether. Such a configuration can lead to increased costs, due in part to several feet of extra wiring. Maintenance of the luminaire also can become more difficult if the luminaire components are not kept together in a single housing. Further, the external wiring and connections may lead to a decreased aesthetic appearance.

Another conventional method of increasing the lifespan of ballasts in luminaire housings is to decrease the power levels of the lamps, which in turn can decrease their brightness or light output. Decreasing the power level and brightness of the lamps will generally decrease the heat generated by the lamps. This reduced heat may reduce the damage to the ballasts, thereby increasing the ballast lifespan. However, lamps with decreased brightness may be less useful in circumstances where bright lighting is desirable or necessary. Further, operating the lamps at a reduced brightness may be inefficient and cause premature failure of the lamps.

Decreasing the power level and brightness of lamps to achieve a greater ballast lifespan may be particularly problematic with luminaires utilizing compact fluorescent lamps (CFLs). Luminaires using CFLs may not emit as much light output when compared to high intensity discharge (HID) lamp luminaires. Thus, decreasing the brightness of CFLs may make CFL luminaires impractical or insufficient for providing necessary lighting in certain applications, such as industrial, commercial, retail, and sports lighting applications where HID lamps may currently be more commonly used. Moreover, decreasing the power level supplied to CFLs may strain the lamp, thereby decreasing the lifespan of the lamp as well.

Therefore, a need in the art exists for providing a luminaire that lacks the limitations described previously. Specifically, a need in the art exists for a luminaire housing that can hold ballasts and lamps disposed therein while reducing the damage to the ballasts caused by heat generated by the lamps. A need in the art also exists for a luminaire that can increase the lifespan of ballasts without reducing the brightness of CFLs or other lamps disposed therein.

### SUMMARY

The present invention provides a luminaire with a single housing for the ballasts and lamps that can reduce the damage to ballasts caused by heat generated by the lamps. Specifically, the invention can provide a luminaire with a single housing having a ballast compartment and a lamp compartment that are at least partially thermally isolated from each other. By thermally isolating the ballasts from at least a portion of the heat generated by the lamps, the luminaire can improve light output when compared to conventional luminaires, while increasing the lifespan of the ballasts. This increased light output can increase the utility of CFLs or other types of lamps used in the luminaires.

For one aspect of the present invention, the luminaire can include housing having a lamp compartment, a ballast compartment, and an air gap chamber disposed therebetween. The air gap chamber can thermally isolate the lamp compartment from the ballast compartment, thereby reducing the heat generated by the lamps that is transferred to the ballasts.

In another aspect of the present invention, the luminaire housing can include a lamp compartment and a ballast compartment. The lamp compartment can have a first wall positioned along the outer perimeter of the lamp compartment. The ballast compartment can include an inner perimeter and an outer perimeter. A second wall can be positioned along the inner perimeter of the ballast compartment. The first wall and the second wall can make up a double wall separating the lamp compartment from the ballast compartment. In such an arrangement, the first wall and the second wall can be separated by the air gap chamber.

The luminaire housing also can include additional features that provide ventilation to reduce the heat transferred from the lamp compartment to the ballast compartment. For example, the luminaire housing can include a perforated top positioned above the lamp compartment, through which heat generated by the lamps may exit the luminaire. Additionally, the luminaire housing can include a door assembly configured to attach to the lamp compartment, while leaving a gap therebetween. This gap can allow ambient air from outside the luminaire to enter the lamp compartment between the door and the lamp compartment and provide improved air circulation in the lamp compartment. The improved air circulation can cause more heat to exit the lamp compartment and the luminaire housing altogether, which in turn reduces the heat transferred to the ballasts in the ballast compartment.

These and other aspects, features, and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of exemplary embodiments of the present invention and the advantages thereof, reference is now made to the following description in conjunction with the accompanying figures described as follows.

FIG. 1 is a top perspective view of a luminaire housing, according to an exemplary embodiment.

FIG. 2 is a cross-sectional view of a portion of the luminaire housing of FIG. 1, according to an exemplary embodiment.

FIG. 3A is a top perspective view of a door assembly for the luminaire housing of FIG. 1, according to an exemplary embodiment.

FIG. 3B is a bottom perspective view of the luminaire housing of FIG. 1 with the door assembly of FIG. 3A attached thereto, according to an exemplary embodiment.

FIG. 3C is a bottom perspective view of the luminaire housing of FIG. 1 depicting the door assembly of FIG. 3A being attached thereto, according to an exemplary embodiment.

FIG. 4A is a top perspective view of the luminaire housing of FIG. 1 with a top assembly attached thereto, according to an exemplary embodiment.

FIG. 4B is an exploded view of the luminaire housing and top assembly of FIG. 4A, according to an exemplary embodiment.

FIG. 5 is a side perspective view of the luminaire housing of FIG. 1 disposed in a pendant mount, according to an exemplary embodiment.

FIG. 6 is a side perspective view of the luminaire housing of FIG. 1 with a suspension cable mount, according to an exemplary embodiment.

### DETAILED DESCRIPTION OF EXEMPLARY EMBODIMENTS

The following description of exemplary embodiments refers to the attached drawings, in which like numerals indicate like elements throughout the several figures.

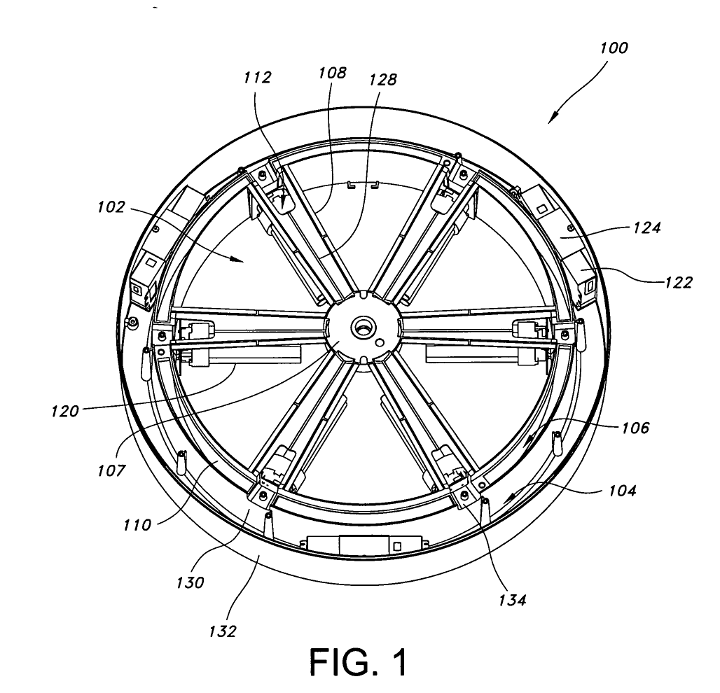

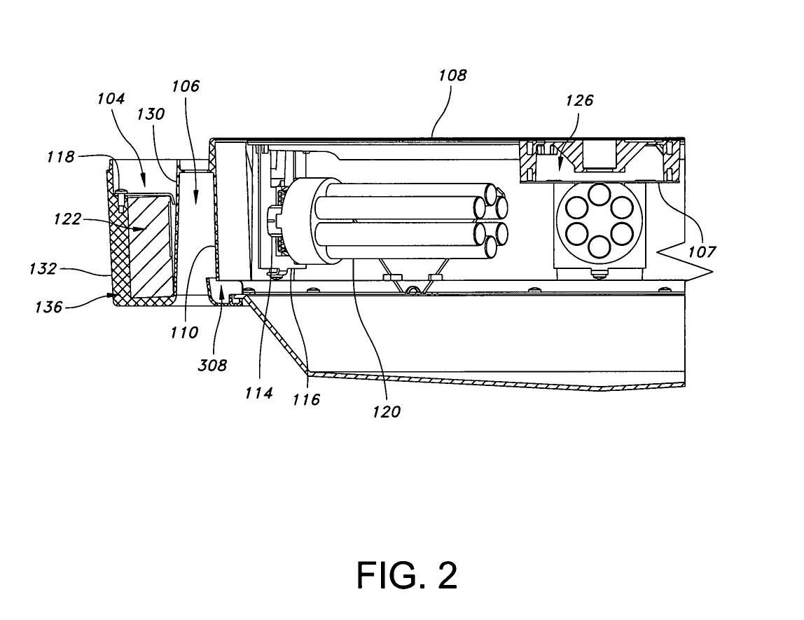

FIG. 1 is a top perspective view of a luminaire housing 100, according to an exemplary embodiment. FIG. 2 is a cross-sectional view of a portion of the luminaire housing 100 of FIG. 1, according to an exemplary embodiment. Exemplary components of the luminaire housing 100 will be described with reference to FIGS. 1 and 2. The luminaire housing 100 includes a ballast compartment 104 and a lamp compartment 102, separated by an air gap chamber 106. The exemplary lamp compartment 102 is arranged in a wheel-and-spoke arrangement, having a center hub portion 107 and six spokes 108. In an alternative exemplary embodiment, lamp holders (not shown) can be mounted to the lamp compartment 102 to provide support to the lamps 120 disposed therein. Lamp holders can either be mounted to a wall of the lamp compartment 102, the bottom of the lamp compartment 102, or the bottom of the spoke 108.

The size of the lamp compartment 102 can vary based on the size and/or number of the lamps 120 that will be housed in the luminaire, as well as the particular application for the luminaire. In certain exemplary embodiments, the lamp compartment 102 is approximately circular in shape and has a diameter between one and three feet, and thus a radius between six and eighteen inches. The radius can be measured from the center of the lamp compartment 102 to an outer wall 110 of the lamp compartment 102. Additionally, though the embodiment illustrated in FIG. 1 includes six spokes 108, in various alternative embodiments, the lamp compartment 102 includes any number of spokes 108, including as few as one spoke 108.

Each exemplary spoke 108 of the lamp compartment 102 serves as a reflector. In one exemplary embodiment, the spokes 108 are painted white, which can diffuse light generated by the corresponding lamps 120. Additionally, each spoke 108 is positioned relative to the lamp 120 such that it directs light emitted by the lamp 120 toward a desired direction. For example, when the luminaire is suspended or attached to a ceiling, the spokes 108 direct light from the lamps 120 downward to provide enhanced illumination to the area beneath the luminaire. Such an exemplary spoke 108 is approximately V-shaped to direct light accordingly. Other shapes can be used, as will be recognized by one of ordinary skill in the art, depending on the location desired to be illuminated by the luminaire. In an alternative embodiment, the lamp compartment 102 can include an additional reflector (not shown) located between each of the spokes 108. Such a reflector can be made of a reflective, metallic material, such as aluminum.

In certain exemplary embodiments, each spoke 108 also includes an opening 112. The opening 112 is positioned directly above the base of the lamp 120. The opening 112 provides ventilation for the lamp 108. In another exemplary embodiment, the lamp compartment 102 and/or each spoke 108 includes an insulating material (not shown) for reducing the amount of heat generated by the lamp 120 that may reach the ballast compartment 104. The insulating material can, for example, include an insulating plastic material. Such insulating material is positioned on the wall 110 of the lamp compartment 102. In certain exemplary embodiments, the insulating material is used in addition to, or instead of, metallic and other non-insulating materials used to form the components of the lamp compartment 102.

In another exemplary embodiment, each spoke 108 also includes a socket bracket 116. The socket bracket 116 is mounted to the lamp compartment 102, and can be attached thereto by a fastener, such as a screw (not shown). In various alternative embodiments, the socket brackets 116 can be mounted to the bottom of the lamp compartment 102 or the bottom of the spoke 108. As will be recognized by one of ordinary skill in the art having the benefit of the present disclosure, the location and/or mounting method of the socket brackets 116 can be varied.

The socket bracket 116 holds a lamp socket 114 within the lamp compartment 102. The socket 114 is configured to accept the insertion of a CFL or other lamp 120 therein, and to allow the removal of the lamp 120 therefrom. The socket 114 is also in electrical communication with a ballast 122 that is used to control the lamp 120.

In certain exemplary embodiments, the lamps 120 housed within the lamp compartment 102 are compact fluorescent lamps (CFLs). The CFLs used include an amalgam in the base of the lamp 120. In a particular embodiment, the amalgam in the base of the lamp 120 includes mercury and other components. The amalgam helps ignite the CFL and helps the CFL provide more consistent light output. In various alternative embodiments, suitable lamps 120 other than CFLs also can be used, as will be recognized by one of ordinary skill in the art having the benefit of the present disclosure. Moreover, regardless of the type of lamps 120 disposed in the lamp compartment 102, lamps 120 with various sizes and/or wattages can be used. In certain exemplary embodiments, the lamps 120 used are CFLs with a wattage between 30 and 120 watts.

Each spoke 108 of the lamp compartment 102 also includes a wire way 128 for power leads (not shown) to go from the ballasts 122 to the center hub 107 for wiring to the incoming line leads (not shown). Power from the ballasts 122 to the lamps 120 is supplied by wires going through the wire ways 128 and the opening 112 above the socket 114 and into the ballast compartment 104. The exemplary lamp compartment 102 further includes a connection 126 for the junction box, which can be a cord with a strain relief or a threaded pipe pendant leading from the junction box to an external junction box (not shown) supplied by the installer. The external junction box connects the internal junction box to multiple power supply circuits.

In certain exemplary embodiments, the ballast compartment 104 houses one or more ballasts 122 connected to one or more of the lamps 120 in the lamp compartment 102. In another exemplary embodiment, the ballast compartment 104 is attached to or integral with the lamp compartment 102. The ballast compartment 104, like the lamp compartment 102, is approximately circular in one exemplary embodiment. The ballast compartment 104 has an inner wall 130 and an outer wall 132, and a corresponding inner diameter and outer diameter. In one exemplary embodiment, the ballast compartment 104 and lamp compartment 102 are substantially concentric, with the inner diameter of the ballast compartment 104 being greater than the diameter of the lamp compartment 102, and the outer diameter of the ballast compartment 104 being greater than the inner diameter. In a particular exemplary embodiment, the width of the ballast compartment 104 (i.e., the distance between the inner 130 and outer walls 132 of the ballast compartment 104) is between two and two-and-a-half inches.

As shown in FIG. 1, in certain exemplary embodiments, three ballasts 122 are used to control the power supplied to the six lamps 120. In various alternative embodiments, any suitable number of ballasts 122 are used to control the lamps 120 in the lamp compartment 102. In one exemplary embodiment, the ballasts 122 vary the power supplied from the junction box to the lamps 120. This can be accomplished in a variety of ways. In one exemplary embodiment, dimming ballasts 122 are used. In such an embodiment, a secondary device, such as a photo-control or motion detector, will control the amount of current to the ballast 122, which in turn will control the current from the ballast 122 to the lamp 120. In another exemplary embodiment, the ballasts 122 are wired from the internal junction box in such a manner as to control the current supplied to each ballast 122 individually, thereby allowing each pair of lamps 120 connected to each ballast 122 to be turned on or off independently. In yet another exemplary embodiment, the central power is wired to an emergency battery pack which will power one ballast 122. The ballast 122 then can power one or two lamps 120 in the event of a power outage.

In certain exemplary embodiments, each ballast 122 is secured within the ballast compartment 104 by a ballast bracket 124. In various exemplary embodiments, the ballast bracket 124 is made of any suitable metallic material, as will be recognized by one of ordinary skill in the art having the benefit of the present disclosure. In a particular exemplary embodiment, the ballast bracket 124 is made from a material such as aluminum that absorbs and/or dissipates heat from the ballasts 122, thereby functioning as a heat sink for the ballast 122.

In another exemplary embodiment, as shown in FIG. 2, the ballast compartment 104 includes a separate heat sink 136. The heat sink 136 is made of any suitable metallic material, such as aluminum. In one exemplary embodiment, the heat sink 136 is integral with the ballast compartment 104.

As will be recognized by one of ordinary skill in the art having the benefit of the present disclosure, the method of securing ballasts 122 in the ballast compartment 104 can be varied in accordance with the invention. In one exemplary embodiment, the ballasts 122 can be secured to the ballast compartment 104 by a fastener such as a screw 118. In such an embodiment, the ballast compartment 104 and the ballast bracket 124 each include a hole through which a screw 118 is inserted to secure the ballast bracket 124 in place. In one particular exemplary embodiment, securing the ballast 122 within the ballast compartment 104 includes placing the ballast 122 within the ballast compartment 104, sliding or placing the ballast bracket 124 over the ballast 122, and fastening the screw 118 to secure the ballast 122 and ballast bracket 124 to the ballast compartment 104.

The luminaire housing 100 also includes an air gap chamber 106 separating the lamp compartment 102 from the ballast compartment 104. In one exemplary embodiment, the air gap chamber 106 also is substantially circular, and is approximately concentric with the lamp compartment 102 and the ballast compartment 104. In other embodiments, the air gap chamber 106, lamp compartment 102, and/or ballast compartment 104 can be of any other shape, such as rectangular or polygonal. In a particular exemplary embodiment, the air gap chamber 106 has a width of approximately one-half inch.

In certain exemplary embodiments, the ballast compartment 104 and lamp compartment 102 are mechanically integrated. For example, although the air gap chamber 106 separates the lamp compartment 102 from the ballast compartment 104, a bridge member 134 connects the ballast compartment 104 and the lamp compartment 102 at one or more locations. In a particular exemplary embodiment, as shown in FIG. 1, a bridge member 134 made of the same material used to make the ballast compartment 104 and/or lamp compartment 102 extends over the air gap chamber 106 and connects the ballast compartment 104 to the lamp compartment 102 at various locations. Specifically, the bridge member 134 extends from each spoke 108 of the lamp compartment 102 to the inner wall 130 of the ballast compartment 104. This mechanical integration of the ballast compartment 104 and lamp compartment 102 facilitates the use of a single luminaire housing 100 to house the ballast compartment 104 and lamp compartment 102. The use of a single luminaire housing 100 provides increased convenience in installing and/or operating the luminaire.

In certain exemplary embodiments, the air gap chamber 106 is defined by a double wall. The double wall is typically made of two separate walls. In one embodiment, the two walls of the double wall are the outer wall 110 of the lamp compartment 102 and the inner wall 130 of the ballast compartment 104. The exemplary double walls are made from aluminum or another suitable metallic, composite, or high temperature thermally insulating thermoplastic material.

Even if the lamp compartment 102 and ballast compartment 104 are mechanically integrated, the air gap chamber 106 can thermally isolate—at least partially—the ballast compartment 104 and the lamp compartment 102. In one exemplary embodiment, air flows into the air gap chamber 106. This air flow provides ventilation for the luminaire, and absorbs some of the heat generated by the lamp 120. The air flow through the air gap chamber 106 thus reduces the amount of heat that is transferred from the lamp compartment 102 to the ballast 122 in the ballast compartment 104. By reducing the amount of heat transferred to the ballast compartment 104, the heat-related damage to the ballast 122 is reduced, and thus, the ballast 122 life span is increased.

In addition, reducing the amount of heat transferred to the ballast compartment 104 also allows the lamps 120 in the lamp compartments 102 to operate at a higher temperature than in conventional luminaires without damaging to the ballasts 122. In certain exemplary embodiments, the luminaire utilizes CFLs, and the CFLs operate at a higher temperature, such as a temperature at or near the optimal operating temperature of the CFLs. If the CFLs operate at or near their optimal temperature, they operate more efficiently and provide increase light output as compared to CFLs that operate at lower temperatures. Thus, the air gap chamber 106, by thermally isolating the lamp compartment 102 from the ballast compartment 104 and dissipating heat generated from the lamps 120, enables luminaires to use CFLs with light output. Such luminaires can be used in applications where bright lighting is desired, such as industrial, commercial, retail, and sports lighting applications where HID lamps 120 may currently be used.

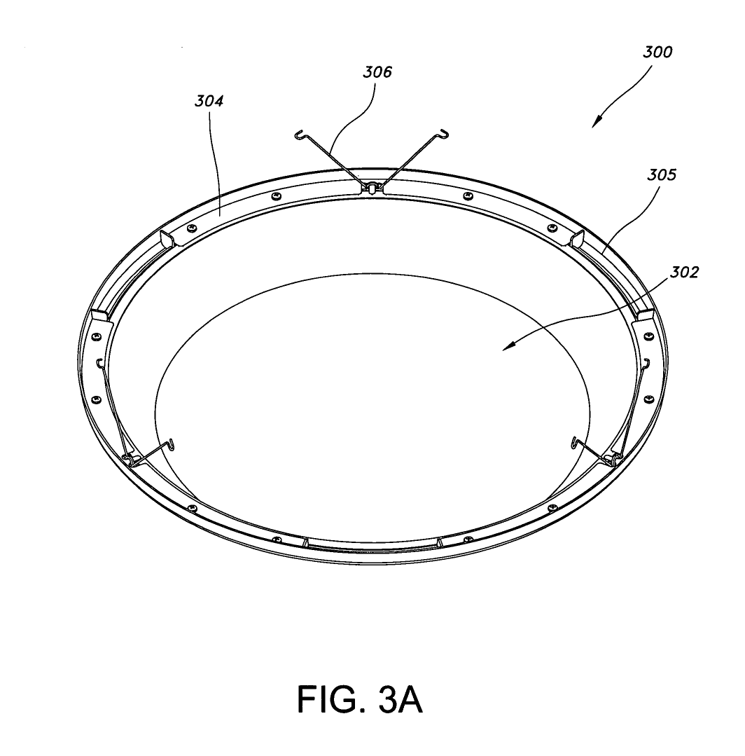

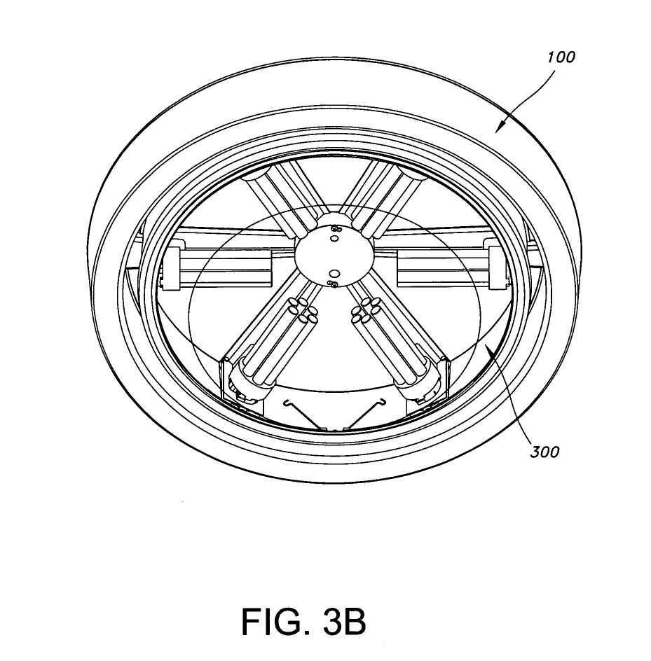

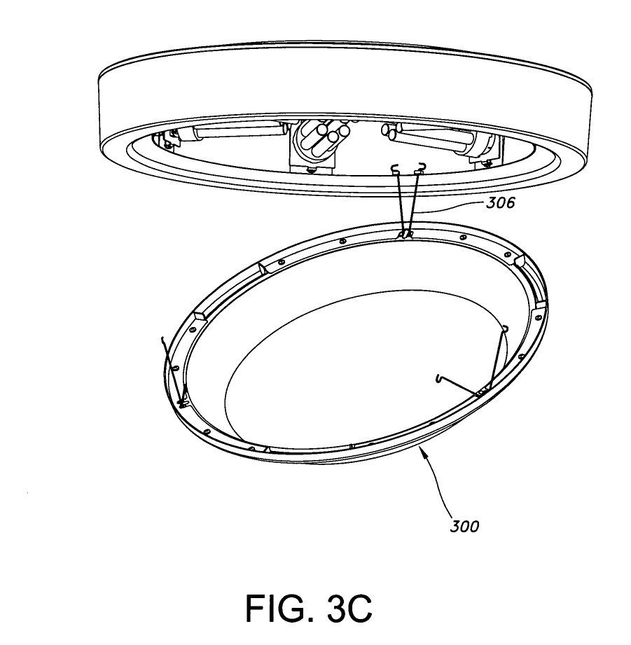

FIG. 3A is a top perspective view of a door assembly 300 for the luminaire housing 100 of FIG. 1, according to an exemplary embodiment. FIG. 3B is a bottom perspective view of the luminaire housing 100 of FIG. 1 with the door assembly 300 of FIG. 3A attached thereto, according to an exemplary embodiment. FIG. 3C is a bottom perspective view of the luminaire housing 100 of FIG. 1 depicting the door assembly 300 of FIG. 3A being attached thereto, according to an exemplary embodiment. Referring now to FIGS. 3A-3C, the exemplary door assembly 300 provides a bottom cover to the luminaire housing 100, enclosing the lamp compartment 102. In certain exemplary embodiments, the door assembly 300 includes a transparent or translucent lens 302, through which at least a portion of the light generated by the luminaire's lamps 120 can pass. The lens 302 is attached to the door assembly 300 via one or more lens retaining brackets 304.

In certain exemplary embodiments, lens retaining brackets 304 are located on the door assembly 300. In one exemplary embodiment, the door assembly 300 includes a lip 305 on which the lens retaining brackets 304 are located. The lip 305 has approximately the same diameter and/or circumferential dimensions as the lamp compartment 102. The door assembly 300 also includes torsion springs 306 for hinging the door assembly 300 to the lamp compartment 102 of the luminaire housing 100 and removing the door assembly 300 therefrom.

In another exemplary embodiment, the door assembly 300 is attached to the lamp compartment 102 and configured to allow for air to flow into the lamp compartment 102. For example, as shown in FIG. 2, an opening 308 or air gap is provided between the outside wall 110 of the lamp compartment 102 and the door assembly 300. In such an embodiment, air flows from outside the luminaire (e.g., from below the luminaire), through the opening 308 between the door assembly 300 and the lamp compartment 102, and into the lamp compartment 102. The air flow improves the ventilation in the lamp compartment 102, by enabling air from outside of the lamp compartment 102 to enter the lamp compartment 102. Taking into account principles of convection, the flow of relatively cool air into the lamp compartment 102 causes the heat generated by the lamps 120 to dissipate, such as through the opening 112 in the spoke 108 described previously.

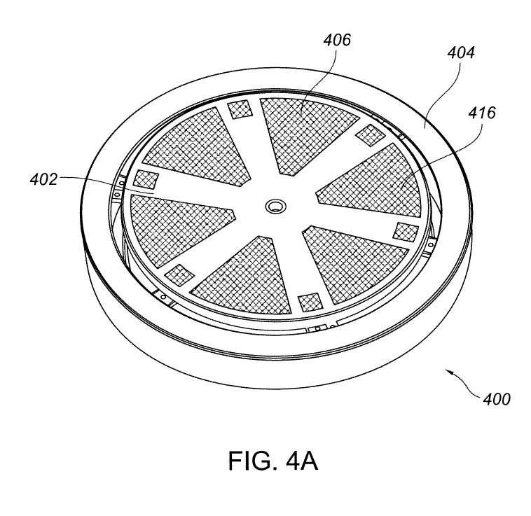

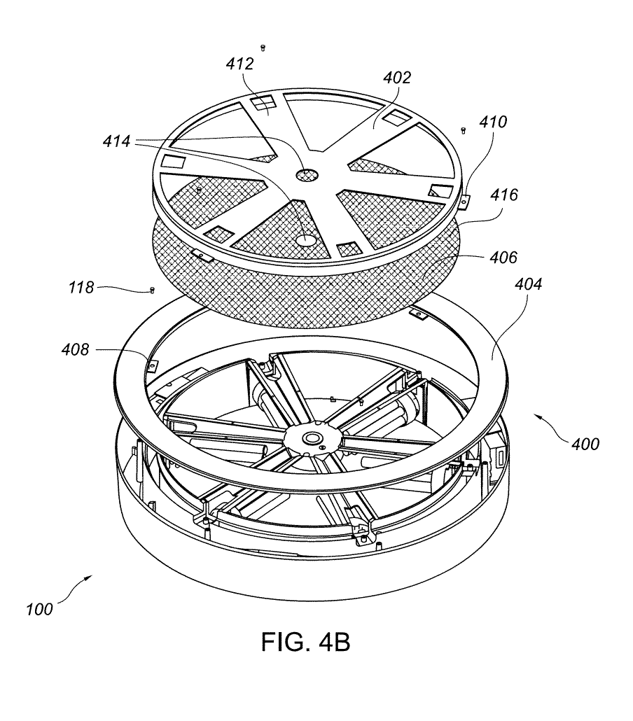

FIG. 4A is a top perspective view of the luminaire housing 100 of FIG. 1 with a top assembly 400 attached thereto, according to an exemplary embodiment. FIG. 4B is an exploded view of the luminaire housing 100 and top assembly 400 of FIG. 4A, according to an exemplary embodiment. Now referring to FIGS. 4A and 4B, the top assembly 400 includes a ballast compartment cover 404, a lamp compartment cover 402, and/or a perforated top 406. In one exemplary embodiment, the lamp compartment cover 402 and perforated top 406 can be made from one piece.

In certain exemplary embodiments, the ballast compartment cover 404 is shaped to fit on top of the ballast compartment 104. For example, the ballast compartment cover 404 is approximately circular, and has an inner diameter and an outer diameter. The inner diameter and outer diameter of the ballast compartment cover 404 is approximately equal to the inner diameter and outer diameter of the ballast compartment 104. In one exemplary embodiment, the ballast compartment cover 404 is made from the same material as the ballast compartment 104. Alternatively, the ballast compartment 104 can be made from a variety of other suitable materials, such as aluminum. As will be recognized by one of ordinary skill in the art having the benefit of the present disclosure, any material—metallic or thermo-plastic—can be used to form the ballast compartment 104, as long as the thermal requirements are met.

In another exemplary embodiment, the ballast compartment cover 404 is placed over the ballast compartment 104 so as to cover the ballasts 122 and ballast brackets 124 therein. This exemplary ballast compartment cover 404 includes tabs 408 along the inner diameter of the ballast compartment cover 404. Screws 118 or other fasteners are inserted into the tabs 408 (and then into corresponding holes in the ballast compartment 104) to secure the ballast compartment cover 404 to the ballast compartment 104. As described previously with reference to securing ballasts 122 to the ballast compartment 104, the method and configuration of securing the ballast compartment cover 404 to the ballast compartment 104 can be varied.

In certain exemplary embodiments, the perforated top 406 is configured to fit over the lamp compartment 102. For example, the perforated top 406 is approximately circular in shape, having approximately the same diameter as the lamp compartment 102. Additionally, the perforated top 406 includes an opening 414 that provides access to the junction box connection 126 in the lamp compartment 102. The opening 414 is typically located approximately in the center of the perforated top 406, such that when the perforated top 406 is placed over the lamp compartment 102, the opening 414 is located above the junction box connection 126.

In another exemplary embodiment, the perforated top 406 is made from a metallic material, such as aluminum. The perforations 416 in the perforated top 406 provide additional ventilation for the lamp compartment 102. Heat generated by the lamps 120 rises and escapes through the perforations 416 in the perforated top 406. The perforations 416 thus help reduce the amount of heat generated by the lamps 120 that is transferred to the ballast compartment 104.

In various exemplary embodiments, the size, number, and/or position of the perforations 416 on the perforated top 406 can vary, as may be recognized by one of ordinary skill in the art having the benefit of the present disclosure. In an alternative embodiment, the top assembly 400 includes a top 406 without perforations 416.

In certain exemplary embodiments, the lamp compartment cover 402 is configured to fit above the perforated top 406. The exemplary lamp compartment cover 402 is shaped similarly to the lamp compartment 102. In one exemplary embodiment, the lamp compartment cover 402 is substantially circular, with a diameter approximately equal to the diameter of the perforated top 406 and/or the lamp compartment 102. In a particular exemplary embodiment, the lamp compartment cover 402 is shaped in a wheel-and-spoke configuration, and has spokes 412 the same as or substantially similar to those described previously with reference to the lamp compartment 102. The lamp compartment cover 402 is designed such that, upon attaching the top assembly 400 to the luminaire housing 100, the spokes 412 of the lamp compartment cover 402 generally align with the spokes 108 of the lamp compartment 102.

In certain exemplary embodiments, the lamp compartment cover 402 is made from the same material as the lamp compartment 102. Alternatively, the lamp compartment cover 402 can be made from a variety of other suitable materials, such as aluminum or a high temperature thermally insulating thermo-plastic material.

In another exemplary embodiment, the lamp compartment cover 402 is placed over the lamp compartment 102 so as to cover the lamps 120 and spokes 108 therein. The exemplary lamp compartment cover 402 includes tabs 410 along its circumference. Screws 118 or other fasteners are inserted into the holes in tabs 410 (and then into corresponding holes in the ballast compartment 104) to secure the lamp compartment cover 402 to the lamp compartment 102.

The top assembly 400 can be attached to the luminaire housing 100. In one exemplary embodiment, the ballast compartment cover 404 is placed on top of the ballast compartment 104 such that the tabs 408 disposed along an inner diameter of the ballast compartment cover 404 are aligned with corresponding holes or openings in the luminaire housing 100. The perforated top 406 is then placed above the lamp compartment 102, and the lamp compartment cover 402 is placed over the perforated top 406. In yet another exemplary embodiment, the lamp compartment cover 402 is placed such that the tabs 410 disposed along the perimeter of the lamp compartment cover 402 are aligned with corresponding holes or openings in the luminaire housing 100. In a particular exemplary embodiment, the holes or openings in the luminaire housing 100, with which the tabs 408, 410 of the ballast compartment cover 404 and lamp compartment cover 402 are aligned, are located on the bridge member 134 of the luminaire housing 100. Fasteners, such as screws 118, are used to attach the lamp compartment cover 402 and ballast compartment cover 404 to the luminaire housing 100. In another exemplary embodiment, the perforated top 406 is secured within the top assembly 400 by being secured between the lamp compartment cover 402 and the ballast compartment cover 404, once the top assembly 400 has been attached to the luminaire housing 100.

An exemplary luminaire housing 100 utilizes one or more of the air gap chambers 106, openings 112 in the spokes 108 of the lamp compartment 102, openings 308 between the door assembly 300 and the lamp compartment 102, and perforations in the top 406 to reduce the heat transferred from the lamps 120 to the ballast compartment 104.

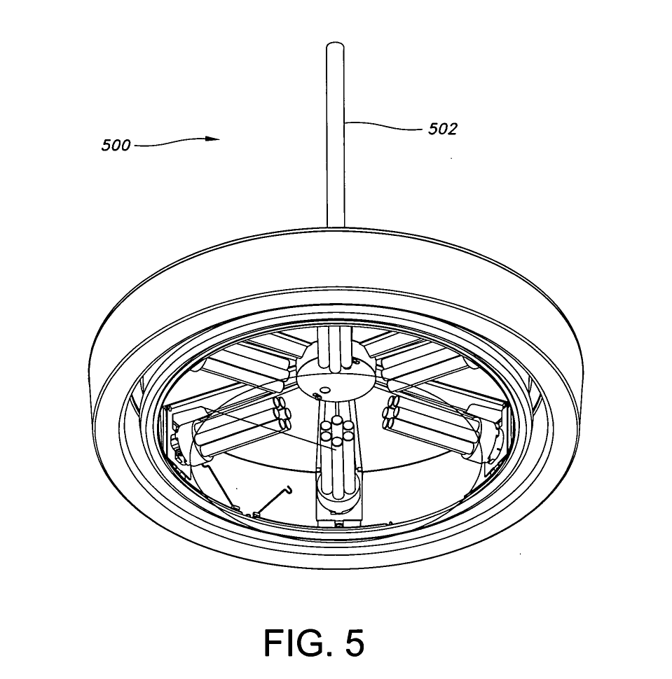

FIG. 5 is a side perspective view of the luminaire housing 100 of FIG. 1 disposed in a pendant mount 500, according to an exemplary embodiment. Referring now to FIG. 5, the exemplary pendant mount 500 includes a pendant 502 or attachment member that provides support to the luminaire housing 100. The pendant 502 can be attached to a ceiling or other surface of the room or area in which the luminaire will be mounted. In another exemplary embodiment, the pendant 502 also houses power cables and other electrical components for use with the luminaire. For example, a portion of wires connecting an external power supply to the junction box can be disposed within the pendant 502.

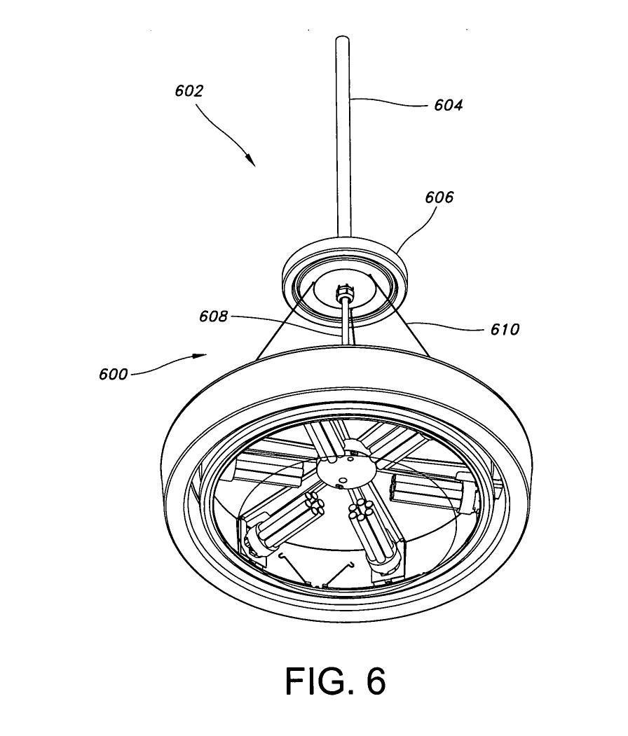

FIG. 6 is a side perspective view of the luminaire housing 100 of FIG. 1 with a suspension cable mount 600, according to an exemplary embodiment. Now referring to FIG. 6, the exemplary suspension cable mount 600 includes an attachment member 602 that, like the pendant 502 of the pendant mount 500 of FIG. 5, provides support to the luminaire housing 100 and houses power cables and other electrical components for use with the luminaire.

In certain exemplary embodiments, the attachment member 602 includes pendant 604, middle junction box 606, and power cord 608 sections. In another exemplary embodiment, the pendant section 604 of the attachment member 602 is attached to a ceiling or other surface of the room or area in which the luminaire will be mounted, and the power cord section 608 is connected to the luminaire housing 100. In a particular exemplary embodiment, the power cord section 608 connects to the top assembly 400 of the luminaire housing 100. In this embodiment, the middle junction box section 606 is attached to or integral with the pendant section 604 and the power cord section 608. In another exemplary embodiment, the middle junction box section 606 receives power from an external junction box (not shown) and provides power to the internal junction box connection 126 in the housing 100.

In another exemplary embodiment, the suspension cable mount 600 further includes suspension cables 610 to support the luminaire housing 100. The suspension cables 610 extend from the middle junction box section 606 to the luminaire housing 100 or top assembly 400 thereof. In a particular exemplary embodiment, the suspension cable mount 600 includes three suspension cables 610 that extend from the middle junction box section 606 to the top assembly 400 of the luminaire housing 100.

In other embodiments, the luminaire housing 100 is attached to a variety of other mounts. For example, the luminaire housing 100 can be attached to a surface mount, for mounting to a surface such as a wall, instead of hanging from a ceiling, as with the pendant mounts 500 and suspension cable mounts 600. Other mounting assemblies also can be used, as may be recognized by one of ordinary skill in the art having the benefit of the present disclosure.

In conclusion, the foregoing exemplary embodiments enable a luminaire with a single housing 100 having a ballast compartment 104 and a lamp compartment 102 that are separated by an air gap chamber 106. Many other modifications, features, and embodiments will become evident to a person of ordinary skill in the art having the benefit of the present disclosure. It should be appreciated, therefore, that many aspects of the invention were described above by way of example only and are not intended as required or essential elements of the invention unless explicitly stated otherwise. It should also be understood that the invention is not restricted to the illustrated embodiments and that various modifications can be made within the spirit and scope of the following claims.

What is claimed is:

1. A housing for a luminaire comprising:
a lamp compartment for housing at least one lamp, wherein the lamp compartment comprises:
a center hub portion; and
a plurality of spokes positioned about the center hub portion, each spoke comprising a first end and a second end, wherein the first end of each spoke is coupled to the center hub portion;
a ballast compartment for housing at least one ballast for controlling the at least one lamp, wherein the ballast compartment is disposed along the second end of each spoke and coupled to at least a portion of at least one of the spokes; and
an air gap chamber disposed between the lamp compartment and the ballast compartment.

2. The housing of claim 1, wherein
each spoke comprises a wire way.

3. The housing of claim 1, wherein the lamp compartment comprises six spokes.

4. The housing of claim 1, wherein each spoke comprises an opening along a top side of the spoke, wherein the opening provides a path of ventilation for heat generated by a lamp, and
wherein the opening is positioned above a socket for securing the lamp therein.

5. The housing of claim 1, wherein the lamp compartment further comprises:
at least one socket for electrically coupling a lamp to one of the ballasts disposed within the ballast compartment, the at least one socket coupled to at least one of the spokes; and
a lamp electrically coupled to each of the sockets.

6. The housing of claim 1, wherein the spokes are disposed in substantially the same plane about the center hub portion.

7. (canceled)

8. The housing of claim 1, wherein the ballast compartment has a substantially circular shape.

9. The housing of claim 1, wherein the spokes are disposed equidistant from each other about the center hub portion.

10. The housing of claim 1, wherein the center hub portion comprises a junction box for electrically coupling the ballasts to a power source.

11. The housing of claim 1, wherein the lamp compartment is circular and has a diameter;
wherein the ballast compartment is circular and has an inner diameter and an outer diameter;
wherein the ballast compartment and lamp compartment are substantially concentric; and
wherein the inner diameter of the ballast compartment is greater than the diameter of the lamp compartment.

12. The housing of claim 1, further comprising a top configured to be positioned above the lamp compartment, wherein at least a portion of the top is perforated.

13. The housing of claim 1, further comprising:
a lamp compartment cover;
a ballast compartment cover; and
a top, wherein a least a portion of the top is perforated;
wherein the ballast compartment cover is configured to be placed on top of the ballast compartment and secured thereto;
wherein the top is configured to be placed on top of the lamp compartment; and
wherein the lamp compartment cover is configured to be placed on top of the at least partially perforated top and coupled to the lamp compartment.

14. The housing of claim 1, further comprising a heat sink coupled to at least one ballast, wherein at least a portion of the heat sink contacts at least one wall of the ballast compartment.

15. The housing of claim 1, further comprising:
a door assembly coupled to the lamp compartment and disposed below the lamp compartment; and
an air gap between the door assembly and the lamp compartment, wherein the air gap allows ambient air to flow into the lamp compartment between the door assembly and the lamp compartment.

16. The housing of claim 1, wherein the lamp compartment is configured to house at least one compact fluorescent lamp.

17. A housing for a luminaire comprising:
a lamp compartment comprising:
a center hub portion;
a first wall disposed about a perimeter of the lamp compartment; and
a plurality of spokes positioned about the center hub portion, each spoke comprising a first end and a second end, wherein the first end of each spoke is coupled to the center hub portion and the second end of each spoke is coupled to the first wall;
a ballast compartment comprising an inner perimeter, an outer perimeter, and a second wall disposed along the inner perimeter of the ballast compartment; and
wherein the lamp compartment and ballast compartment are separated by a double wall assembly comprising the first wall and the second wall.

18. The housing of claim 17, wherein the first wall and second wall are separated by a distance of at least 0.25 inches.

19. The housing of claim 17, wherein the first wall and the second wall are separated by a distance between 0.25 inches and 1.0 inch.

20. The housing of claim 17, further comprising an air gap chamber disposed between the first wall and the second wall.

21. The housing of claim 17, further comprising at least one bridge member extending between the first wall and the second wall and coupling the lamp compartment to the ballast compartment.

22. The housing of claim 17, wherein at least one spoke is attached to a socket configured to secure a lamp therein.

23. The housing of claim 17, wherein the lamp compartment further comprises:
at least one socket for electrically coupling a lamp to one of the ballasts disposed within the ballast compartment, the at least one socket coupled to at least one of the spokes; and
a lamp electrically coupled to each of the sockets.

24. The housing of claim 17, further comprising:
a lamp compartment cover;
a ballast compartment cover configured to be placed on top of the ballast compartment and secured thereto; and
a perforated top configured to be placed on top of the lamp compartment, wherein the lamp compartment cover is configured to be placed on top of the perforated top and secured to the lamp compartment.

25. The housing of claim 17, wherein the lamp compartment is configured to house at least one compact fluorescent lamp.

26. A housing for a luminaire comprising:
a lamp compartment comprising:
a center hub portion;
a plurality of spokes positioned about the center hub portion, each spoke comprising a first end and a second end, wherein the first end of each spoke is coupled to the center hub portion; and
at least one lamp socket configured to house at least one compact fluorescent lamp, the at least one lamp socket coupled to at least one of the spokes;
a ballast compartment configured to house at least one ballast for controlling at least one lamp, each ballast electrically coupled to the at least one lamp, the ballast compartment being disposed along the second end of each spoke and coupled to at least a portion of at least one of the spokes;
at least one bridge member coupled along a first side to the lamp compartment and along a second side to the ballast compartment, wherein each bridge member extends over an air gap chamber.

27. The housing of claim 26, wherein the air gap chamber is disposed between the lamp compartment and the ballast compartment.

28. A housing for a luminaire comprising:
a lamp compartment for housing at least one lamp, the lamp compartment comprising:
a center hub portion; and
a plurality of spokes positioned about the center hub portion, each spoke comprising a first end and a second end, wherein the first end of each spoke is coupled to the center hub portion;
a ballast compartment for housing at least one ballast for controlling the at least one lamp; and
an air gap chamber disposed between the lamp compartment and the ballast compartment,
wherein the center hub portion comprises a junction box for electrically coupling the ballasts to a power source.

29. The housing of claim 28, wherein the lamp compartment is circular and has a diameter;
wherein the ballast compartment is circular and has an inner diameter and an outer diameter;
wherein the ballast compartment and lamp compartment are substantially concentric; and
wherein the inner diameter of the ballast compartment is greater than the diameter of the lamp compartment.

30. The housing of claim 28, further comprising:
a door assembly coupled to the lamp compartment and disposed below the lamp compartment; and
an air gap between the door assembly and the lamp compartment, wherein the air gap allows ambient air to flow into the lamp compartment between the door assembly and the lamp compartment.
